(19) United States
(12) Patent Application Publication
(10) Pub. No.: US 2016/0045851 A1
(43) Pub. Date: Feb. 18, 2016

(54) ONE TYPE OF PIPE AIR PURIFIER

(71) Applicants: Stephen Kells Swenerton, Boulder, CO (US); He Zhijun, Hartford, WI (US)

(72) Inventors: Stephen Kells Swenerton, Boulder, CO (US); He Zhijun, Hartford, WI (US)

(21) Appl. No.: 14/826,605

(22) Filed: Aug. 14, 2015

(30) Foreign Application Priority Data
Aug. 15, 2014 (CN) 201420464277.5

(51) Int. Cl. B01D 46/00; B01D 46/42; B01D 46/44

(52) U.S. Cl. CPC B01D 46/0023; B01D 46/442; B01D 46/0036; B01D 46/4254; B01D 46/009

(57) ABSTRACT

The present utility model relates to an air purifier, in particular to a duct-type air purifier. To overcome the inadequacy of existing air purifiers in being unable to supply filtered fresh air to multiple rooms simultaneously, the present utility model provides a duct-type air purifier. The purifier comprises a panel assembly, a basic-efficiency filter, a high-efficiency filter, a middle frame assembly, a motor assembly, a box, and an air output system. The air purifier is installed on the ceiling of a room, and can not only effectively absorb pollutants such as dust in high-level air, but also save indoor space for a user, and can also supply filtered fresh air to multiple rooms simultaneously.

### TECHNICAL FIELD

The present utility model relates to an air purifier, in particular to a duct-type air purifier.

### BACKGROUND ART

At present, most known indoor air purifiers have a tabletop or standing structure, and must be arranged on a table or floor during use. However, large amounts of dust in indoor air, including partly respirable particles (particulates with a particle size of 10 microns or less are generally called PM10, and also called respirable particulates or air-borne dust) and very fine particulates (which means particulates in the atmosphere with a diameter less than or equal to 2.5 microns, commonly called PM2.5), are suspended in high-level air indoors due to the effect of buoyancy. The absorption effect of conventional tabletop or standing air purifiers on such dust is limited. Moreover, conventional tabletop or standing air purifiers must be arranged on a table or floor, taking up usable indoor space, and causing great inconvenience, and furthermore cannot supply filtered fresh air to multiple rooms simultaneously.

### CONTENT OF THE INVENTION

To overcome the inadequacy of existing air purifiers in being unable to supply filtered fresh air to multiple rooms simultaneously, the present utility model provides a duct-type air purifier. The air purifier is fixed to the roof and/or ceiling of a room, and can not only effectively absorb pollutants such as dust in high-level air while saving indoor space for a user, but can also supply filtered fresh air to multiple rooms simultaneously.

To solve the above technical problem, the present utility model employs the following technical solution:

The present utility model provides a duct-type air purifier, comprising a panel assembly, a basic-efficiency filter, a high-efficiency filter, a middle frame assembly, a motor assembly, a box, and an air output system; the box has a bottom face, and comprises a filter chamber and an air discharge chamber; a partition plate is designed between the filter chamber and the air discharge chamber, the partition plate being provided with a through-hole on a side close to the bottom face; the middle frame assembly is installed above the filter chamber, with the high-efficiency filter, basic-efficiency filter and panel assembly being installed on the middle frame assembly in sequence from the inside to the outside; an air inlet is formed between the panel assembly and middle frame assembly; the air discharge chamber is divided into a top layer and a bottom layer; the layer which includes the bottom face is an air intake passage, which is in communication with the filter chamber via the through-hole in the partition plate; a box cover is disposed above the top layer of the air discharge chamber, the motor assembly being installed beneath the box cover; the motor assembly comprises a motor, an air intake end and an air output end; the air output system is installed on a side of the air discharge chamber; the air output system comprises an air output duct, with an air outlet being disposed on the air output duct; the air output end of the motor assembly is in communication with the air output system;

under the sucking action of the motor, indoor air enters the interior of the middle frame assembly through the air inlet formed between the panel assembly and middle frame assembly, is filtered by the basic-efficiency filter and high-efficiency filter, enters the filter chamber, enters the bottom layer of the air discharge chamber via the through-hole in the partition plate, enters the air output system via the air intake end and air output end of the motor assembly, and then is discharged via the air output duct and air outlet.

Once the motor assembly is powered on, the motor rotates to generate a sucking force, and the air purifier begins to purify indoor air; once the motor assembly is powered off, the motor gradually stops, and no longer generates a sucking force, at which time the air purifier stops operating.

The duct-type air purifier described above is installed below a roof or on a ceiling; air outlets of the air output system are distributed in multiple different rooms, and can supply filtered fresh air to multiple different rooms simultaneously.

Hanging hooks are installed on an external side of the box. The box further comprises installation hanger rods connected to the hanging hooks.

The installation hanger rods may be installation threaded rods.

The installation hanger rods can suspend the box beneath a roof.

Furthermore, in the air purifier, the panel assembly comprises a control panel and an air intake panel; the middle frame assembly comprises an air intake frame and a control frame, with the air intake frame being installed above the filter chamber, and the air intake panel, basic-efficiency filter and high-efficiency filter being installed on the air intake frame; the control frame extends towards a region above the air discharge chamber, covering part of a sealing plate above the air discharge chamber, and the control panel is disposed on the control frame.

Furthermore, the purifier further comprises a remote controller, a main control circuit board is installed on the control frame, a sensor and an indicator lamp are installed on the control panel, and the main control circuit board is connected by electric wires to the motor, sensor and indicator lamp.

Furthermore, in the air purifier, the air output system comprises mutually connected air output ducts; the air output ducts and air outlets are distributed in multiple different rooms, and can supply filtered fresh air to multiple different rooms simultaneously.

Furthermore, in the air purifier, a fan is disposed in the air output duct, for delivering filtered fresh air to the air outlet.

Furthermore, in the air purifier, multiple air outlets are disposed on the air output duct. The air outlets are distributed in different rooms.

Furthermore, in the air purifier, the air output system comprises a connecting pipe disposed on a side of the top layer of the air discharge chamber; fresh air blown out of the air output end enters a ventilation duct of the air output system through the connecting pipe.

Furthermore, in the air purifier, the panel assembly is fixed to the middle frame assembly by means of a fixed rotation shaft and a holding magnet; that side of the panel assembly which is provided with the holding magnet is opened, and the panel assembly is rotated unilaterally by means of the fixed rotation shaft on another side.

An advantage of such a design of panel assembly is that: there is no need to remove the panel assembly when a filter is to be replaced or cleaned.

Furthermore, in the air purifier, the basic-efficiency filter is of nylon material, while the high-efficiency filter is formed of a combination of two layers of material, namely high-density composite paper and activated carbon.

The basic-efficiency filter mainly filters suspended particles in indoor air; the high-efficiency filter mainly filters fine particulates and harmful gases in indoor air.

Furthermore, in the air purifier, the sensor is used for measuring a particulate concentration in air; when the particulate concentration exceeds a certain value, the sensor can automatically turn on the motor, and when the particulate concentration falls to a certain value, the sensor can automatically turn off the motor.

Furthermore, in the air purifier, the indicator lamp comprises a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

When the air purifier is operating in the first running mode, the motor rotates at high speed, and the air purifier operates with high efficiency. When the air purifier is operating in the second running mode, the motor rotates at low speed, and the efficiency with which the air purifier purifies air is lower.

When it is necessary to turn off the air purifier, a manual form of turn-off is employed: the power supply is disconnected. The indicator lamp on the air purifier is extinguished.

Furthermore, in the air purifier, the remote controller comprises a manual mode and an automatic mode; when the remote controller is in the automatic mode, the sensor automatically begins to operate.

Furthermore, in the air purifier, the main control circuit board is used for receiving signals transmitted by the sensor, and turning the motor on or off according to the signals transmitted by the sensor.

Furthermore, in the air purifier, the high-efficiency filter comprises an electronic indicating means, for indicating whether the high-efficiency filter has been installed properly; when the high-efficiency filter has been installed properly, the electronic indicating means transmits a signal to the main control circuit board, and the main control circuit board puts the air purifier into a state in which the latter is able to operate.

The air purifying function of the product is mainly realized through two-stage filtration by two filter elements. Indoor air first passes through the basic-efficiency filter, which is of nylon material and mainly filters fine hair, hairs and large-radius suspended particles in indoor air; the air then passes through the high-efficiency filter, which is formed of a combination of two layers of material, namely high-density composite paper and activated carbon. The high-density composite paper can mainly filter very fine particulates in indoor air; the activated carbon can adsorb harmful gases. The basic-efficiency filter can be washed in water and used repeatedly; the high-efficiency filter must be replaced periodically to guarantee the purification effect.

The box of the duct-type air purifier provided by the present utility model may be installed on a roof or ceiling, to achieve the objective of sucking in indoor air at all heights from the top of a room and performing purification.

Compared to existing tabletop or standing indoor purifiers, the indoor purifier provided in the present application can effectively remove respirable particles, very fine particulates and bacteria etc. from air, can save usable indoor space, and can supply filtered fresh air to multiple rooms simultaneously. In addition, the duct-type air purifier provided in the present application can be installed and dismantled conveniently, enables the primary filter to be removed easily for cleaning, and enables the high-level filter to be replaced easily.

### DESCRIPTION OF THE ACCOMPANYING DRAWINGS

FIG. 1 is a schematic diagram showing how the duct-type air purifier provided by the present utility model is assembled;

FIG. 2 is a perspective drawing of the duct-type air purifier suspended from a roof;

FIG. 3 is an installation schematic diagram showing how the duct-type air purifier is suspended from a roof;

FIG. 4 is a side view of the duct-type air purifier;

FIG. 5 is a view of the duct-type air purifier from below;

FIG. 6 is a schematic diagram of the air flow route inside the air purifier;

FIG. 7 is a structural schematic diagram of the purifier box of the duct-type air purifier.

In the figures: 1 is the panel assembly, 2 is the basic-efficiency filter, 3 is the high-efficiency filter, 4 is the middle frame assembly, 5 is the motor assembly, 6 is the box, 7 is the air output system, 701 is the air output duct, 702 is the air outlet, 703 is the fan; 101 is the air inlet, 102 is the air intake panel, 103 is the control panel, 502 is the air intake end, 503 is the air output end, 401 is the air intake frame, 402 is the control frame, 600 is the bottom face, 601 is the filter chamber, 602 is the air discharge chamber, 603 is the partition plate, 6030 is the through-hole, 6021 is the box cover, 604 is the hanging hook, 605 is the hanger rod, 100 is dirty air, 200 is fresh air, 300 is the roof.

### PARTICULAR EMBODIMENTS

The present utility model is explained further below in conjunction with the accompanying drawings and embodiments.

### Embodiment 1

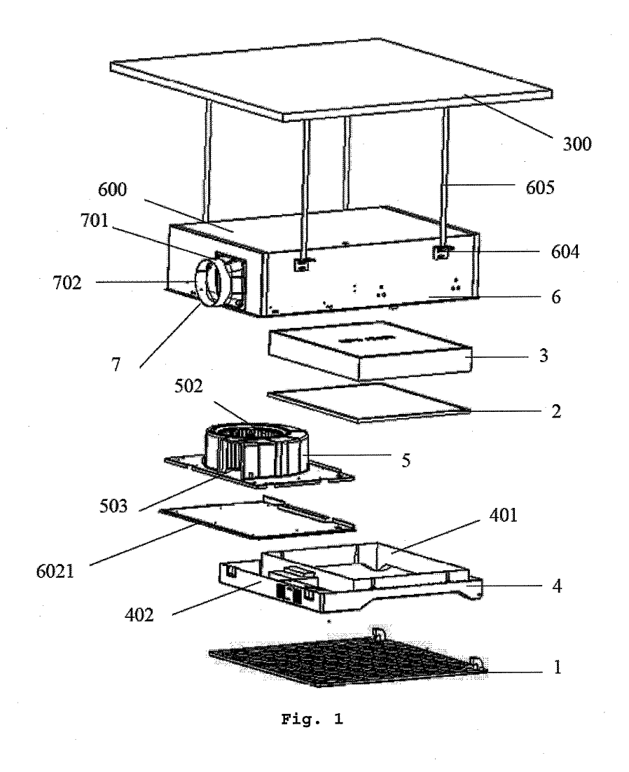

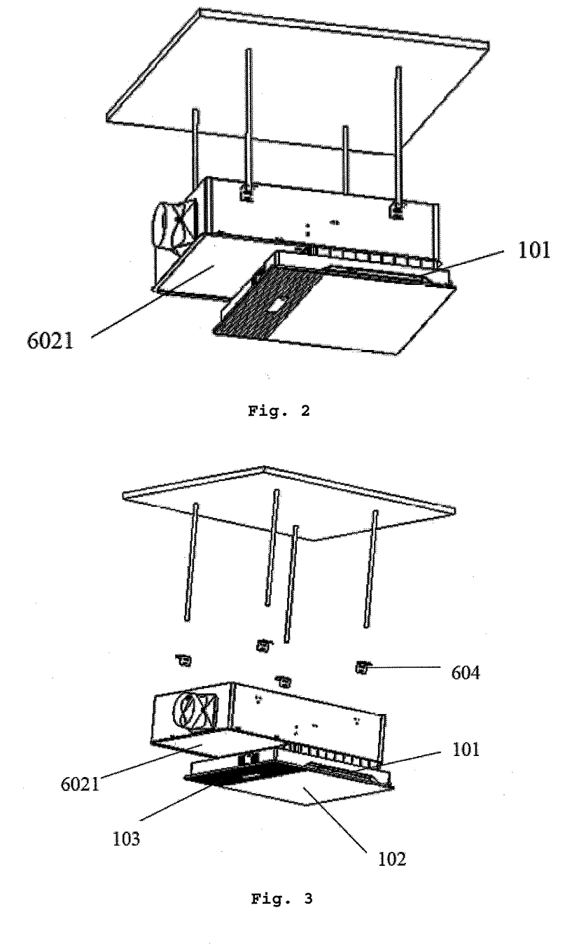

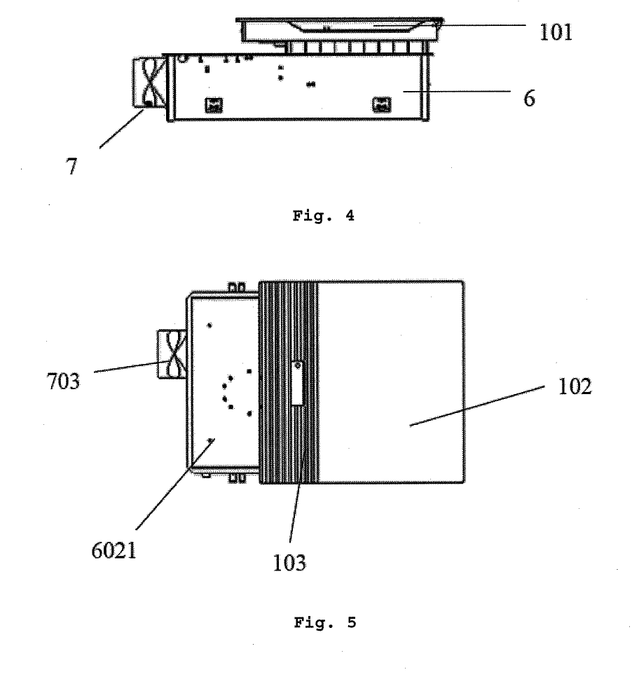

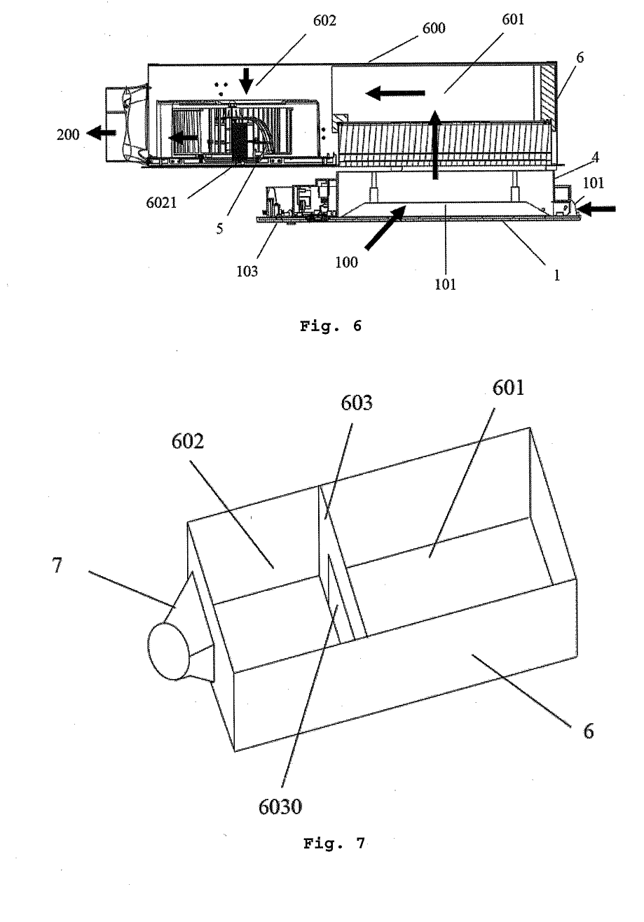

As FIGS. 1 to 7 show, the present invention provides a duct-type air purifier, comprising a panel assembly 1, a basic-efficiency filter 2, a high-efficiency filter 3, a middle frame assembly 4, a motor assembly 5, a box 6, and an air output system 7; the box 6 has a bottom face 600, and comprises a filter chamber 601 and an air discharge chamber 602. A partition plate 603 is designed between the filter chamber 601 and the air discharge chamber 602, the partition plate 603 being provided with a through-hole 6030 on a side close to the bottom face 600. The middle frame assembly 4 is installed above the filter chamber 601, with the high-efficiency filter 3, basic-efficiency filter 2 and panel assembly 1 being installed on the middle frame assembly 4 in sequence from the inside to the outside. An air inlet 101 is formed between the panel assembly 1 and middle frame assembly 4. The air discharge chamber 602 is divided into a top layer and a bottom layer; the layer which includes the bottom face 600 is an air intake passage, which air intake passage is in communication with the filter chamber 601 via the through-hole 6030 in the partition plate 603. A box cover 6021 is disposed above the top layer of the air discharge chamber 602, the motor assembly 5 being installed beneath the box cover 6021; the motor assembly 5 comprises a motor, an air intake end 502 and an air output end 503. The air output system 7 is installed on a side of the air discharge chamber 602; the air output system 7 comprises an air output duct 701, with an air outlet 702 being disposed on the air output duct 701. The air output end 503 of the motor assembly 5 is in communication with the air output system 7.

Under the sucking action of the motor, indoor air enters the interior of the middle frame assembly 4 through the air inlet 101 formed between the panel assembly 1 and middle frame assembly 4, is filtered by the basic-efficiency filter 2 and high-efficiency filter 3, enters the filter chamber 601, enters the bottom layer of the air discharge chamber 602 via the through-hole 6030 in the partition plate 603, enters the air output system 7 via the air intake end 502 and air output end 503 of the motor assembly 5, and then is discharged via the air output duct 701 and air outlet 702.

Once the motor assembly is powered on, the motor rotates to generate a sucking force, and the air purifier begins to purify indoor air; once the motor assembly is powered off, the motor gradually stops, and no longer generates a sucking force, at which time the air purifier stops operating.

The duct-type air purifier described above is installed below a roof or on a ceiling; air outlets of the air output system are distributed in multiple different rooms, and can supply filtered fresh air to multiple different rooms simultaneously.

Hanging hooks 604 are installed on an external side of the box. The box further comprises installation hanger rods 605 connected to the hanging hooks 604. The installation hanger rods 605 can suspend the box 6 beneath a roof 300.

### Embodiment 2

The present invention provides an air purifier as described in embodiment 1, and furthermore, the panel assembly 1 comprises a control panel 103 and an air intake panel 102; the middle frame assembly 4 comprises an air intake frame 401 and a control frame 402, with the air intake frame 401 being installed above the filter chamber 601, and the air intake panel 102, basic-efficiency filter 2 and high-efficiency filter 3 being installed on the air intake frame 401; the control frame 402 extends towards a region above the air discharge chamber 602, covering part of a sealing plate 6021 above the air discharge chamber 602, and the control panel 103 is disposed on the control frame 402.

The purifier further comprises a remote controller, a main control circuit board is installed on the control frame 402, a sensor and an indicator lamp are installed on the control panel 103, and the main control circuit board is connected by electric wires to the motor, sensor and indicator lamp.

The air output system 7 comprises mutually connected air output ducts 701; the air output ducts 701 and air outlets 702 are distributed in multiple different rooms, and can supply filtered fresh air to multiple different rooms simultaneously.

A fan 703 is disposed in the air output duct 701, for delivering filtered fresh air to the air outlet.

Multiple air outlets are disposed on the air output duct. The air outlets are distributed in different rooms.

The air output system comprises a connecting pipe disposed on a side of the top layer of the air discharge chamber; fresh air blown out of the air output end enters a ventilation duct of the air output system through the connecting pipe.

The panel assembly is fixed to the middle frame assembly by means of a fixed rotation shaft and a holding magnet; that side of the panel assembly which is provided with the holding magnet is opened, and the panel assembly is rotated unilaterally by means of the fixed rotation shaft on another side.

The basic-efficiency filter is of nylon material, while the high-efficiency filter is formed of a combination of two layers of material, namely high-density composite paper and activated carbon.

The basic-efficiency filter mainly filters suspended particles in indoor air; the high-efficiency filter mainly filters fine particulates and harmful gases in indoor air.

The sensor is used for measuring a particulate concentration in air; when the particulate concentration exceeds a certain value, the sensor can automatically turn on the motor, and when the particulate concentration falls to a certain value, the sensor can automatically turn off the motor.

The indicator lamp comprises a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

When the air purifier is operating in the first running mode, the motor rotates at high speed, and the air purifier operates with high efficiency. When the air purifier is operating in the second running mode, the motor rotates at low speed, and the efficiency with which the air purifier purifies air is lower.

When it is necessary to turn off the air purifier, a manual form of turn-off is employed: the power supply is disconnected. The indicator lamp on the air purifier is extinguished.

The remote controller comprises a manual mode and an automatic mode; when the remote controller is in the automatic mode, the sensor automatically begins to operate.

The main control circuit board is used for receiving signals transmitted by the sensor, and turning the motor on or off according to the signals transmitted by the sensor.

The high-efficiency filter comprises an electronic indicating means, for indicating whether the high-efficiency filter has been installed properly; when the high-efficiency filter has been installed properly, the electronic indicating means transmits a signal to the main control circuit board, and the main control circuit board puts the air purifier into a state in which the latter is able to operate.

The embodiments above are merely preferred embodiments of the present invention, which are not intended to define the scope of protection thereof. All equivalent changes and modifications made according to the content of the present invention shall be included in the patent scope thereof.

1. Duct-type air purifier, characterized in that the purifier comprises a panel assembly, a basic-efficiency filter, a high-efficiency filter, a middle frame assembly, a motor assembly, a box, and an air output system; the box has a bottom face, and comprises a filter chamber and an air discharge chamber; a partition plate is designed between the filter chamber and the air discharge chamber, the partition plate being provided with a through-hole on a side close to the bottom face; the middle frame assembly is installed above the filter chamber, with the high-efficiency filter, basic-efficiency being installed on the filter and panel assembly middle frame assembly in sequence from the inside to the outside; an air inlet is formed between the panel assembly and middle frame assembly; the air discharge chamber is divided into a top layer and a bottom layer; the layer which includes the bottom face is an air intake passage, which is in communication with the filter chamber via the throughhole in the partition plate; a box cover is disposed above the top layer of the air discharge chamber, the motor assembly being installed beneath the box cover; the motor assembly comprises a motor, an air intake end and an air output end; the air output system is installed on a side of the air discharge chamber; the air output system comprises an air output duct, with an air outlet being disposed on the air output duct; the air output end of the motor assembly is in communication with the air output system;
under the sucking action of the motor, indoor air enters the interior of the middle frame assembly through the air inlet formed between the panel assembly and middle frame assembly, is filtered by the basic-efficiency filter and high-efficiency filter, enters the filter chamber, enters the bottom layer of the air discharge chamber via the through-hole in the partition plate, enters the air output system via the air intake end and air output end of the motor assembly, and then is discharged via the air output duct and air outlet.

2. Air purifier according to claim 1, characterized in that the panel assembly comprises a control panel and an air intake panel; the middle frame assembly comprises an air intake frame and a control frame, with the air intake frame being installed above the filter chamber, and the air intake panel, basic-efficiency filter and high-efficiency filter being installed on the air intake frame; the control frame extends towards a region above the air discharge chamber, covering part of a sealing plate above the air discharge chamber, and the control panel is disposed on the control frame.

3. Air purifier according to claim 2, characterized in that the purifier further comprises a remote controller, a main control circuit board is installed on the control frame, a sensor and an indicator lamp are installed on the control panel, and the main control circuit board is connected by electric wires to the motor, sensor and indicator lamp.

4. Air purifier according to claim 1, characterized in that the air output system comprises mutually connected air output ducts; the air output ducts and air outlets are distributed in multiple different rooms, and can supply filtered fresh air to multiple different rooms simultaneously.

5. Air purifier according to claim 1, characterized in that a fan is disposed in the air output duct, for delivering filtered fresh air to the air outlet.

6. Air purifier according to claim 1, characterized in that multiple air outlets are disposed on the air output duct.

7. Air purifier according to claim 1, characterized in that the air output system comprises a connecting pipe disposed on a side of the top layer of the air discharge chamber; fresh air blown out of the air output end enters a ventilation duct of the air output system through the connecting pipe.

8. Air purifier according to claim 1, characterized in that the panel assembly is fixed to the middle frame assembly by means of a fixed rotation shaft and a holding magnet; that side of the panel assembly which is provided with the holding magnet is opened, and the panel assembly is rotated unilaterally by means of the fixed rotation shaft on another side.

9. Air purifier according to claim 7, characterized in that the basic-efficiency filter is of nylon material, while the high-efficiency filter is formed of a combination of two layers of material, namely high-density composite paper and activated carbon.

10. Air purifier according to claim 3, characterized in that the sensor is used for measuring a particulate concentration in air; when the particulate concentration exceeds a certain value, the sensor can automatically turn on the motor, and when the particulate concentration falls to a certain value, the sensor can automatically turn off the motor.

11. Air purifier according to claim 10, characterized in that the indicator lamp comprises a red signal lamp and a blue signal lamp, and the sensor is able to control the indicator lamp; when the particulate concentration detected by the sensor reaches a certain value, the air purifier begins to operate in a first running mode, and the red signal lamp on the air purifier lights up; when the particulate concentration is lower than a certain value, the air purifier begins to operate in a second running mode, and the blue signal lamp lights up; the blue signal lamp remains lit until the air purifier begins to operate in the first running mode again.

12. Air purifier according to claim 10, characterized in that the remote controller comprises a manual mode and an automatic mode; when the remote controller is in the automatic mode, the sensor automatically begins to operate.

13. Air purifier according to claim 10, characterized in that the main control circuit board is used for receiving signals transmitted by the sensor, and turning the motor on or off according to the signals transmitted by the sensor.

14. Air purifier according to claim 13, characterized in that the high-efficiency filter comprises an electronic indicating means, for indicating whether the high-efficiency filter has been installed properly; when the high-efficiency filter has been installed properly, the electronic indicating means transmits a signal to the main control circuit board, and the main control circuit board puts the air purifier into a state in which the latter is able to operate.
